(19) United States
(12) Patent Application Publication
(10) Pub. No.: US 2026/0237304 A1
(43) Pub. Date: Aug. 13, 2026

(54) Method of determining an aircraft trajectory with a noise abatement procedure during takeoff following a total pseudo-slope setpoint, associated method, system and aircraft

(71) Applicant: DASSAULT AVIATION, SAINT-CLOUD (FR)

(72) Inventors: William FAYSSE, SAINT-CLOUD CEDEX (FR); Jean-Noël ALBRIEUX, SAINT-CLOUD CEDEX (FR); Thibaut BARDON, SAINT-CLOUD CEDEX (FR); Yann COUREAUD, MERIGNAC (FR); Jean-Baptiste VALLART, Istres Cedex (FR); Bruno RECHAIN, MERIGNAC (FR)

(21) Appl. No.: 19/536,195

(22) Filed: Feb. 10, 2026

(30) Foreign Application Priority Data
Feb. 11, 2025 (FR) FR 25 01383
Feb. 11, 2025 (FR) FR 25 01385

(51) Int. Cl. G08G 5/52; B64D 43/00; G01C 21/20

(52) U.S. Cl. CPC G08G 5/52; B64D 43/00; G01C 21/20

(57) ABSTRACT

A method of determining an aircraft trajectory with a noise abatement procedure during takeoff following a total pseudo-slope setpoint is implemented using a determination system and includes the following steps: the determination of characteristics of at least one initial trajectory segment made at maximum thrust up to a predefined minimum altitude, the determination of characteristics of at least one trajectory segment with a noise abatement with reduced thrust compared to the maximum thrust to reach a setpoint speed, and determining characteristics of at least one trajectory segment with a noise abatement including defining at least one total pseudo-slope setpoint ensuring reduced thrust.

### BACKGROUND

This present disclosure provides a method to determine an aircraft trajectory with a noise abatement departure procedure, the determination method being implemented with a determination system comprising the following steps:
determining characteristics of at least one initial trajectory segment made at a maximum thrust up to a predefined minimum altitude;
determining characteristics of at least one trajectory segment with a noise abatement at a reduced thrust compared to the maximum thrust to reach a setpoint speed.

The aircraft trajectory with a noise abatement is intended to be implemented during takeoff of an aircraft, to minimize the impact of noise, particularly from aircraft engines, on the ground.

Such a noise reduction procedure during takeoff (referred to as “Noise Abatement Departure Procedure” or the acronym “NADP”) is generally implemented in the vicinity of terrain having a high population density at distances more or less close to the terrain. The procedure aims to reduce the ground noise footprint of the aircraft during takeoff on a trajectory segment away from the terrain.

There are two main types of noise abatement departure procedures. In a first type (classified as “close in”), a reduction in engine thrust is made at a first altitude, such as 244 meters (800 feet), while maintaining a constant speed, then an aircraft acceleration is made once a higher altitude is reached, such as from 914 meters (3000 feet).

In a second type (classified as “distant”), an acceleration phase is made from 244 meters (800 feet), without significant reduction in engine thrust, so as to retract the slats and flaps. Then, a reduction in thrust is made at a higher altitude, to achieve noise abatement.

The thrust reduction setpoints are generally based on a reduction in engine speed, by acting on the engine speed level (“rating”), on the percentage N1 of engine rotation speed compared to the maximum rotation speed in normal mode, or on a ratio between the turbine discharge pressure and the compressor inlet pressure (“Engine Pressure Ratio” or “EPR”), for example.

In a variant, the setpoint to be respected for the noise abatement is defined by a vertical parameter, particularly a vertical speed or a slope.

Such thrust reduction control modes do not provide complete satisfaction.

For certain procedures, the reduction in thrust by adjusting the engine speed is complex to implement and requires adaptation to daily conditions.

In mission preparation, implementing noise reduction requires using tables with multiple entries (aircraft configuration, aircraft weight, altitude, temperature) depending on the flight conditions, which can be complicated to manage.

During the mission itself, it is sometimes difficult to achieve a sufficient reduction in thrust in terms of noise.

In some cases, the trajectories obtained after implementation of the noise reduction are difficult for the pilot to achieve.

### SUMMARY

An aim of the present disclosure is thus to provide a method that enables determining an aircraft trajectory with a noise abatement departure procedure, which is simple for the crew to implement or can be carried out automatically, while offering very effective noise reduction and adapted to the specific terrains over which the aircraft flies.

To this end, the present disclosure aims to provide a method of the aforementioned type, characterized in that determining characteristics of at least one trajectory segment with a noise abatement comprises defining at least one total pseudo-slope setpoint ensuring the reduced thrust.

The method of determination according to the present disclosure may comprise one or more of the following features, taken individually or in any technically possible combination:
determining characteristics of at least one trajectory segment with a noise abatement comprises defining characteristics of a first trajectory segment comprising a constant speed and a first total pseudo-slope setpoint;
the value of the first total pseudo-slope setpoint is between 3° and 7°;
determining characteristics of at least one trajectory segment with a noise abatement, beyond a second threshold altitude, comprises defining characteristics of a second trajectory segment comprising a second total pseudo-slope setpoint ensuring aircraft acceleration from the constant speed to the setpoint speed, with the value of the second total pseudo-slope setpoint advantageously being greater than the value of the first total pseudo-slope setpoint;
the value of the second total pseudo-slope setpoint is between 3° and 8°;
the second trajectory segment, after reaching the setpoint speed, comprises an increase in the aircraft slope to a value corresponding to the second total pseudo-slope setpoint;
determining at least one trajectory segment with a noise abatement with a reduced thrust compared to the maximum thrust is made from the predefined minimum altitude of a first initial trajectory segment, or determining characteristics of at least one initial trajectory segment comprises determining a first initial trajectory segment up to a predefined minimum altitude, then determining a second initial trajectory segment, from the first predefined minimum altitude to a second predefined minimum altitude, during which the flaps and slats are retracted, with determining of at least one trajectory segment with a noise abatement with reduced thrust compared to the maximum thrust being made from the second predefined minimum altitude;
the method comprises defining a floor slope to be respected by the aircraft corresponding to the or each trajectory segment with a noise abatement with a reduced thrust;
the method comprises displaying a representation of the trajectory, on a determination system screen, comprising the initial trajectory segment and the or each trajectory segment with a noise abatement and/or transmitting the characteristics of the initial trajectory segment and defined characteristics of the or each trajectory segment with a noise abatement, to an aircraft flight management system, advantageously to display on a cockpit screen at least one total pseudo-slope guidance symbol corresponding to the total pseudo-slope setpoint ensuring the reduced thrust.

The present disclosure also aims to provide a method to pilot an aircraft following a trajectory with a noise abatement departure procedure, comprising the following steps:
following at least one initial trajectory segment made at a maximum thrust up to a predefined minimum altitude;
following at least one trajectory segment with a noise abatement with a reduced thrust compared to the maximum thrust to reach a setpoint speed, characterized in that following the at least one trajectory segment with a noise abatement comprises following at least one total pseudo-slope setpoint ensuring the reduced thrust.

The piloting method according to the present disclosure may comprise one or more of the following characteristics, taken individually or in any technically possible combination:
following at least one trajectory segment with a noise abatement comprises following a first trajectory segment with a constant speed and a first total pseudo-slope setpoint;
following of at least one trajectory segment with a noise abatement comprises, beyond a second threshold altitude, following a second trajectory segment having a second total pseudo-slope setpoint ensuring an acceleration of the aircraft from constant speed to setpoint speed, the value of the second total pseudo-slope setpoint being greater than the value of the first total pseudo-slope setpoint.

The present disclosure also aims to provide a system to determine an aircraft trajectory with a noise abatement departure procedure, comprising:
a module for determining characteristics of at least one initial trajectory segment made at a maximum thrust up to a predefined minimum altitude;
a module for determining characteristics of at least one trajectory segment with a noise abatement with a reduced thrust compared to the maximum thrust to reach a setpoint speed, characterized in that the determination module of the at least one trajectory segment with a noise abatement is configured to define at least one total pseudo-slope setpoint ensuring the reduced thrust.

The system according to the present disclosure may comprise a screen and a display manager on the screen, configured to display a representation of the trajectory comprising the initial trajectory segment and the or each trajectory segment with a noise abatement and/or may comprise a module for transmitting the characteristics of the initial trajectory segment and defined characteristics of the or each trajectory segment with a noise abatement to a flight management system of the aircraft, the system advantageously comprising a cockpit screen and a display manager on the cockpit screen configured to display on the cockpit screen at least one total pseudo-slope guidance symbol corresponding to the total pseudo-slope setpoint ensuring reduced thrust.

The present disclosure also aims to provide an aircraft comprising a flight management system configured to follow or guide a pilot along a trajectory with a noise abatement departure procedure, the trajectory comprising:
at least one initial trajectory segment made at a maximum thrust up to a predefined minimum altitude;
at least one trajectory segment with a noise abatement with a reduced thrust compared to the maximum thrust to reach a setpoint speed,
characterized in that at least one trajectory segment with a noise abatement is defined by at least one total pseudo-slope setpoint ensuring the reduced thrust.

The present disclosure also provides a method to determine a trajectory of an aircraft with a noise abatement departure procedure during takeoff, the determination method being implemented using a determination system comprising the following steps:
determining characteristics of at least one initial trajectory segment made at maximum thrust up to a predefined minimum altitude;
determining of characteristics of at least one trajectory segment with a noise abatement at reduced thrust compared to the maximum thrust to reach a target speed;
defining at least one floor slope to be observed by the aircraft in correspondence with the or each trajectory segment with a noise abatement.

The determination method according to the present disclosure may comprise one or more of the following characteristics, taken individually or in any technically possible combination:
the method comprises the definition of a plurality of floor slope sections, each floor slope section defining a distinct floor slope;
the method comprises at least two trajectory segments with noise abatement, the respective floor slope sections associated with each trajectory segment with a noise abatement having different floor slopes from one another;
defining each floor slope section is carried out based on a mapping defining at least one obstacle or trajectory constraint, notably an airport gradient, in view of the or each trajectory segment with a noise abatement;
the method comprises defining a common floor slope corresponding to several trajectory segments with a noise abatement;
the method comprises defining a unique floor slope for all trajectory segments with noise abatement from a final point of the initial trajectory segment at the predefined minimum altitude;
determining the characteristics of at least one trajectory segment with noise abatement comprises defining at least one slope or total pseudo-slope instruction ensuring reduced thrust, the floor slope being equal to the slope or total pseudo-slope instruction minus a margin for taking into account external atmospheric conditions and/or the floor slope being equal to the slope necessary to ensure an acceleration of the aircraft greater than a given minimum acceleration threshold;
the method comprises displaying, on a screen of the determination system, a representation of the trajectory comprising the initial trajectory segment and the or each trajectory segment with a noise abatement, with the floor slope to be observed by the aircraft in correspondence with the or each trajectory segment with a noise abatement; and/or transmitting the characteristics of the initial trajectory segment and the defined characteristics of the or each trajectory segment with a noise abatement, as well as the floor slope to be observed by the aircraft in correspondence with the or each trajectory segment with a noise abatement, to a flight management system of the aircraft.

The present disclosure also provides a method to pilot an aircraft following a trajectory of an aircraft trajectory with a noise abatement departure procedure, comprising the following steps:
following an initial trajectory segment performed at maximum thrust up to a predefined minimum altitude;
following at least one trajectory segment with noise abatement with a reduced thrust compared to maximum thrust to reach a target speed, characterized by maintaining a slope of the aircraft above a floor slope to be observed by the aircraft defined in correspondence with the or each trajectory segment with a noise abatement with reduced thrust, during the implementation of the or each trajectory segment with noise abatement.

The piloting method according to the present disclosure may comprise one or more of the following characteristics, taken individually or in any technically possible combination:
the method comprises, during the implementation of at least one trajectory segment with noise abatement, following at least one slope or total pseudo-slope instruction ensuring reduced thrust, the floor slope being equal to the slope or total pseudo-slope instruction minus a margin for taking into account external atmospheric conditions or being equal to the slope necessary to ensure an acceleration of the aircraft greater than a given minimum acceleration threshold;
the method comprises, during the implementation of at least one trajectory segment with noise abatement, comparing a real slope of the aircraft with the floor slope, and issuing alert information in case the real slope becomes lower than the floor slope;
the method comprises implementing automatic piloting of the aircraft to restore a real slope greater than the floor slope in case the real slope becomes lower than the floor slope.

The present disclosure also provides a determination system for an aircraft trajectory with a noise abatement departure procedure, comprising:
a module for determining characteristics of an initial trajectory segment performed at maximum thrust up to a predefined minimum altitude;
a module for determining characteristics of at least one trajectory segment with a noise abatement with reduced thrust compared to maximum thrust to reach a target speed, characterized by:
a module for defining at least one floor slope to be observed by the aircraft in correspondence with the or each trajectory segment with a noise abatement.

The present disclosure also provides an aircraft comprising a flight management system configured to follow or guide a pilot along an aircraft trajectory with a noise abatement departure procedure, the trajectory comprising:
an initial trajectory segment performed at maximum thrust up to a predefined minimum altitude;
at least one trajectory segment with a noise abatement with reduced thrust compared to maximum thrust to reach a target speed, characterized in that the flight management system is configured to maintain at least one floor slope to be observed by the aircraft in correspondence with the or each trajectory segment with a noise abatement.

### BRIEF DESCRIPTION OF THE DRAWINGS

The present disclosure will be better understood by reading the following description, given solely as an example, and referring to the appended drawings, wherein:

FIG. 1 is a schematic view of relevant elements of an aircraft according to the present disclosure, equipped with a determination system according to the present disclosure;

FIG. 2 is a cross-sectional view in a vertical plane of an aircraft trajectory with a noise abatement departure procedure, obtained by the method of determination according to the present disclosure;

FIG. 3 is a view of a detail of the trajectory during a noise abatement departure phase;

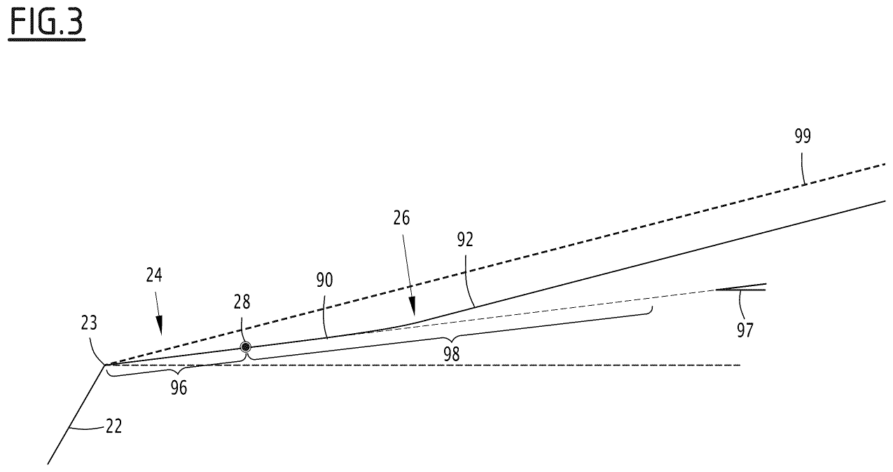

FIG. 4 is a view of a trajectory variant, similar to FIG. 2;

FIG. 5 is a view, similar to FIG. 2, of a floor slope to be respected by the aircraft corresponding to trajectory segments with noise abatements, and of a slope actually flown by the aircraft; and

FIG. 6 is a schematic view of a cockpit screen presented to the pilot during the aircraft flight.

### DETAILED DESCRIPTION

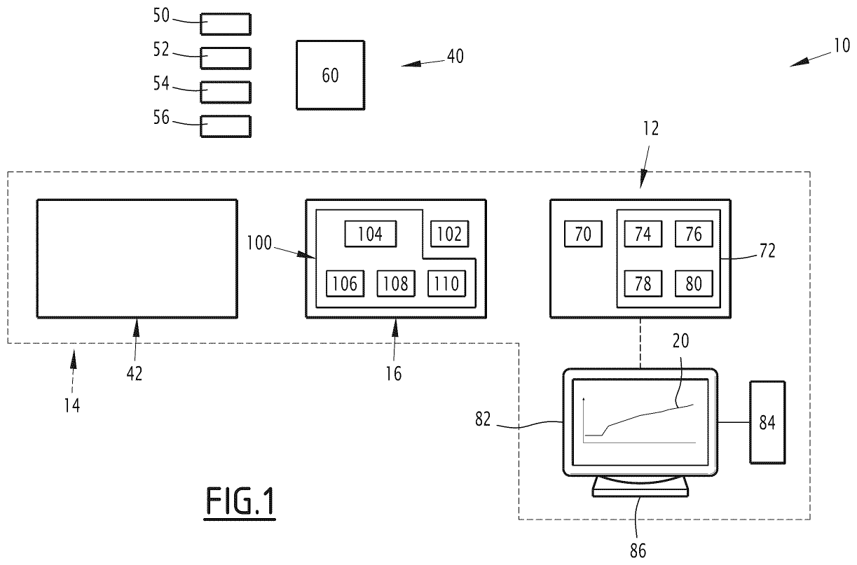

A method for determining a trajectory 20 with a noise abatement departure procedure for an aircraft 10 is implemented in a determination system 12, schematically represented in FIG. 1.

The determination system 12 is embedded onboard the aircraft 10, for example, integrated within the avionics 14 of the aircraft, for example. The determination system 12 is connected to a flight management system 16 (or FMS) in particular, which enables the crew to determine and/or implement a horizontal and vertical trajectory of the aircraft 10 during a mission of the aircraft 10.

In a variant, the determination system 12 is integrated into a non-embedded offboard mission planning system, such as within an airport infrastructure for establishing aircraft trajectories, in an electronic flight bag (or “EFB”) and/or in a portable electronic device such as a tablet or in a PC or ground server.

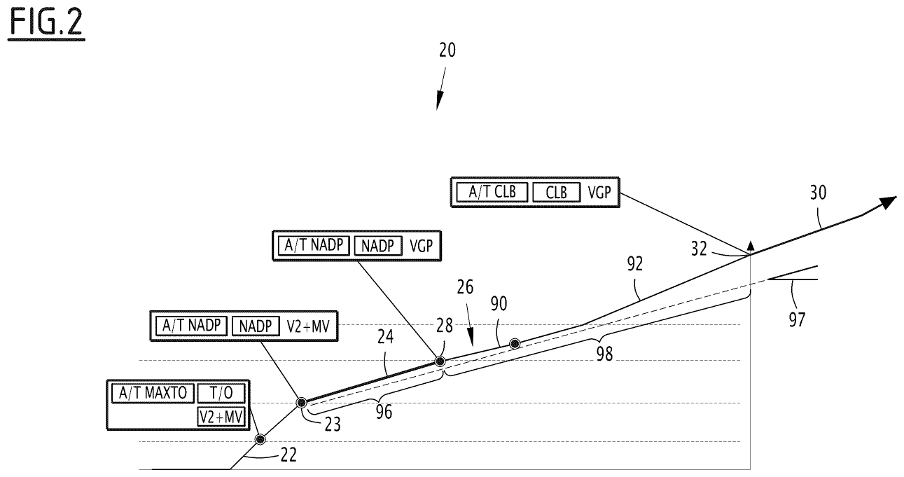

An example of a trajectory 20 with a noise abatement departure procedure, as determined by the determination system 12, is illustrated in FIG. 2, for a close-in noise abatement procedure.

The trajectory 20 visible in FIG. 2 comprises an initial trajectory segment 22, made with a maximum thrust and a determined slope from the ground to a predefined minimum altitude 23 for initiating a noise abatement. It then comprises at least one trajectory segment 24, 26 with a noise abatement with a reduced thrust to reach a setpoint speed VGP.

The trajectory 20 here comprises two successive noise abatement segments, 24, 26.

The trajectory 20 thus includes a first segment 24, made at constant speed V2+MV, and, according to the present disclosure, following a first total pseudo-slope setpoint TD_{NRED}, ensuring a reduced thrust.

It also includes a second segment 26, implemented from a second minimum altitude 28, following a second total pseudo-slope setpoint TD_{NACC} in which the aircraft speed increases to the setpoint speed VGP and the aircraft 10 then tends to reach a slope substantially equal to the second total pseudo-slope setpoint TD_{NACC}. In this example, the value of the second total pseudo-slope setpoint TD_{NACC} is greater than the value of the first total pseudo-slope setpoint TD_{NRED}.

More generally, the trajectory 20 may comprise more than two successive noise abatement segments, with each noise abatement segment being associated with a respective entry altitude and a total pseudo-slope setpoint.

The trajectory 20 then comprises a climb segment 30, implemented from an altitude 32 chosen by the pilot or by the flight management system 16.

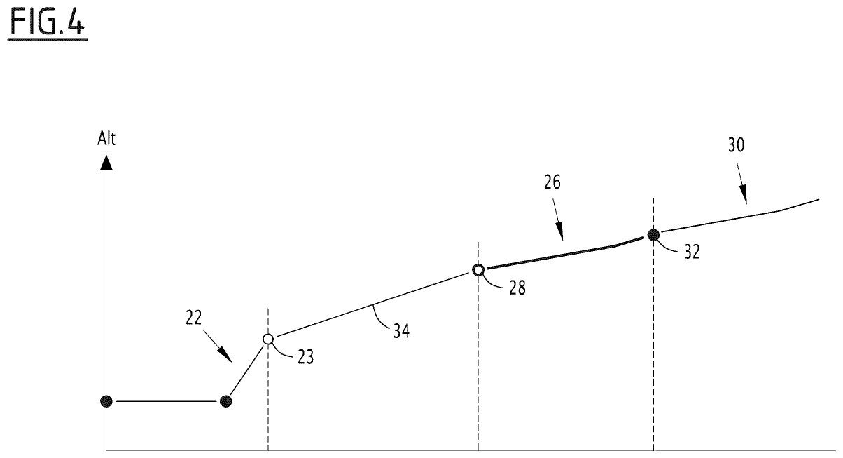

In a second example represented in FIG. 4, for a distant abatement procedure, the trajectory 20 comprises the first initial segment 22, then, at the end of the first initial segment 22, a second initial segment 34, at the first altitude 23, during which the flaps and slats are retracted, with a total pseudo-slope setpoint for this second initial segment being equal to the pseudo slope TO at maximum engine speed.

The trajectory 20 then comprises a distant noise abatement segment 24, made with a constant total pseudo-slope setpoint TD_{NACC}. In this latter case, the value of the total pseudo-slope setpoint TD_{NACC} of the distant noise abatement segment 24 is less than the value of the pseudo slope TO.

Referring to FIG. 1, in addition to the flight management system 16, the aircraft 10 further comprises a mechanical energy management device 40 enabling control of the energy variation of the aircraft 10 from a total pseudo-slope setpoint, an autopilot system 42 connected to the flight management system 16 and to the mechanical energy variation management device 40 to execute automatic pilot commands of the aircraft 10, particularly concerning the mechanical energy variation of the aircraft 10 and its horizontal and/or vertical trajectory.

The aircraft 10 also includes several propulsion engines 50, mechanical energy modification organs 52 of the aircraft 10, flight parameter measurement sensors 54 and a flight control center 56, configured to control each engine 50, and the mechanical energy modification organs 52.

Each propulsion engine 50 is configured to be piloted by the flight control center 56, to vary a thrust force on the aircraft 10, increasing or decreasing the total mechanical energy of the aircraft 10.

Advantageously, the mechanical energy modification organs 52 are organs for modification of the drag of the aircraft 10. They include airbrakes, deployable slats and/or flaps or landing gear, for example. Each mechanical energy modification organ 52 is configured to be piloted by the flight control center 56 to vary a drag force on the aircraft 10, decreasing or increasing the total mechanical energy of the aircraft 10.

Each propulsion engine 50 and each mechanical energy modification organ 52 thus constitute a source of variation of the mechanical energy of the aircraft 10.

The flight parameter measurement sensors 54 are configured particularly to determine the position, altitude, air and ground speeds, as well as the air and ground slopes of the aircraft 10.

The flight control center 56 includes at least one processor and a memory containing multiple software modules suitable for being executed by the processor.

The memory contains one module in particular for developing the commands of the engines 50 and developing commands for the mechanical energy modification organs 52.

Advantageously, it contains a module for calculating a quantity representing the mechanical energy variation of the aircraft, expressed as a total pseudo-slope, depending on the flight parameters.

The command development module is configured to calculate the commands of the engines 50 and the mechanical energy modification organs 52 based on a setpoint received from the energy management device 40 when the aircraft 10 is in manual piloting mode, or based on a setpoint received from the autopilot system 42 when the aircraft 10 is in autopilot mode.

The module for calculating the quantity representing the mechanical energy variation is configured, for example, to calculate a current mechanical energy variation of the aircraft and a range of mechanical energy variations likely to be reached by the aircraft 10 at any time, depending on the flight parameters obtained from the sensors 54 and the operational situation of the aircraft.

The operational situation of the aircraft 10 includes the evolution of the aircraft 10 on the ground or in flight in particular and the equipment available, in particular the number of engines 50 and the individual thrust developed by each engine 50 and the number of mechanical energy modification organs 52 and the position of each mechanical energy modification organ 52.

The quantity representing the mechanical energy variation here is a total pseudo-slope, as calculated in patent FR 2 958 033 of the Applicant. This total pseudo-slope is defined as the ground slope, which leads to a constant conventional speed, under current conditions.

The total pseudo-slope γ* is calculated by the following formula, for example:

$${γ}^{*} = {γ}_{sol} + \frac{{( \frac{\partial {V}_{air}}{\partial {V}_{c}} )}_{z = cste}}{1 + \frac{{V}_{sol}}{g} \cdot {( \frac{\partial {V}_{air}}{\partial z} )}_{Vc = cste}} \frac{{\dot{V}}_{c}}{g} = {γ}_{sol} + K \cdot \frac{{\dot{V}}_{c}}{g}$$

where γₛₒₗ is the ground slope of the aircraft 10, Vₛₒₗ is the speed of the aircraft 10 relative to the ground, Vₐᵢᵣ is the airspeed of the aircraft 10, V_{c} is the conventional speed of the aircraft 10, g is the acceleration due to gravity, and z is the altitude of the aircraft 10.

The energy management device 40 preferably includes a lever 60, movable on a control course that enables the pilot to define a total pseudo-slope setpoint value when manual piloting.

Advantageously, the flight control center 56 then includes a module for controlling the position of the movable lever 60 on the control course, configured to develop a position command of the movable lever 60 depending on the current total pseudo-slope and the range of total pseudo-slope variations likely to be reached by the aircraft 10.

The position calculated by the movable lever 60 reflects the total pseudo-slope of the aircraft 10 in the range of total pseudo-slope variations likely to be reached by the aircraft 10. This position is referred to as a “mobile neutral” position and varies over time without user intervention following the evolution configuration of the aircraft 10, in the autopilot mode.

The bounds of the range of total pseudo-slope variations likely to be reached also vary over time, depending on the situation of the aircraft (particularly position, speed, attitude, available thrust, available drag, etc.).

The maintenance of the total pseudo-slope of the aircraft 10, and thus the position of the mobile neutral, is advantageously controlled by the autopilot system 42 in the autopilot mode.

The total pseudo-slope of the aircraft 10 can also be manually adjusted by the pilot by moving the movable lever 60 away from the mobile neutral position to define a new desired total pseudo-slope setpoint, in the range of total pseudo-slope variations likely to be reached by the aircraft 10.

Referring to FIG. 1, the determination system 12 of the trajectory 20 advantageously includes at least one computer having at least one processor 70 and a memory 72 containing multiple software modules suitable for being executed by the processor 70.

In a variant, the determination system 12 at least partially takes the form of one or more programmable circuits, such as the FPGA type (“Field-Programmable Gate Array”) or in the form of a dedicated electronic circuit of the ASIC type (“Application-Specific Integrated Circuit”).

In this example, the determination system 12 comprises a module 74 for determining characteristics of the initial segment 22, a module 76 for determining characteristics of each trajectory segment 24, 26 with a noise abatement, and a module 78 for defining a floor slope to be respected by the aircraft 10 corresponding to the or each trajectory segment 24, 26 with a noise abatement.

Advantageously, the determination system 12 comprises a module 80 for transmitting the characteristics of the trajectory 20 to the flight management system 16.

The determination system 12 preferably includes at least one display screen 82 and a display manager 84 for displaying information on the display screen 82, particularly for displaying a graphical representation of the trajectory 20 in a vertical plane, intended to be viewed by the pilot, and a human-machine interface 86.

The module 74 for determining the characteristics of the initial trajectory segment 22 is configured to define the first predefined minimum altitude 23 up to which maximum thrust is applied, as well as the value of the maximum thrust applied. It is also configured to determine a setpoint slope of the aircraft 10 on this initial segment 22.

In the example of FIG. 1, the initial trajectory segment 22 is associated with a flight management mode of the flight management system 16, particularly a takeoff T/O mode of the flight management system 16.

The predefined minimum altitude 23 is between 200 m and 500 m, for example, particularly equal to 244 meters (800 feet). This altitude is defined as an altitude above the terrain (“above airport elevation” or AAE in English).

The maximum takeoff thrust, defined by a percentage value N1 of engine rotation speed compared to the maximum rotation speed in normal mode, for example, is greater than 75%, particularly between 85% and 100%.

The determination module 74 for the characteristics of the initial trajectory segment 22 is configured to define an initial speed VI, in the initial segment 22, equal to the takeoff speed V2 plus a speed margin MV.

The determination module 76 of the trajectory segments 24, 26 is configured to determine each trajectory segment 24, 26 with a noise abatement by defining at least one total pseudo-slope setpoint TD_{NRED}, TD_{NACC}, ensuring reduced thrust and thus a noise abatement.

Therefore, the determination module 76 is configured to define the first trajectory segment 24 with a noise abatement from the first predefined minimum altitude 23 while maintaining a speed equal to the takeoff speed V2 plus a defined speed margin MV. The speed margin MV is between 9 km/h (5 knots) and 46 km/h (25 knots), for example, particularly equal to 28 km/h (15 knots).

The determination module 76 is configured to define a first total pseudo-slope setpoint TD_{NRED} in this first trajectory segment with a noise abatement 24.

Preferably, the first total pseudo-slope setpoint TD_{NRED} is a constant value for a type of aircraft 10, calculated beforehand during the design of the aircraft 10, and stored in the memory 72.

In a variant, the first total pseudo-slope setpoint TD_{NRED} is determined before the flight, during the establishment of the flight plan of the aircraft 10, for example.

Advantageously, the first total pseudo-slope setpoint TD_{NRED} is calculated from the characteristics of the aircraft 10, in particular its type, its number of engines, its maximum thrust and/or minimum thrust, noise constraints to be respected, defined on the terrain(s) of interest, and performance characteristics to be met established by the aircraft manufacturer, particularly operational criteria such as minimum slopes imposed by the airport and applicable regulatory criteria, such as the Advisory Circular 91-53A, “Noise Abatement Departure Profile”, of the Federal Aviation Administration.

The use of a constant total pseudo-slope value defines a single setpoint that depends on the aforementioned constraints and can be used universally without consulting tables that depend on the configuration, weight, altitude, temperature, as in the case of a setpoint of percentage value N1 of engine rotation speed.

The total pseudo-slope setpoint can thus be a single constant value that will enable respecting a particular criterion, such as passing the steepest of all minimum slopes imposed by airports, or a range of lower slopes, but enabling stronger thrust reductions. In the second case, if a slope is encountered that is steeper than the defined one, the chosen total pseudo-slope setpoint value is then modified.

Advantageously, the value of the first total pseudo-slope setpoint TD_{NRED} is between 3° and 7°, for example.

In the example of FIG. 2, the determination module 76 is configured to determine the end of the first segment 24 and the start of the second segment 26 at the second altitude 28 greater than the first predefined minimum altitude 23, such as between 762 m (2500 feet) and 1067 m (3500 feet), in particular equal to 914 m (3000 feet).

The determination module 76 is configured to define a second total pseudo-slope setpoint TD_{NACC}, in this second trajectory segment with a noise abatement 26, with a value greater than the value of the first total pseudo-slope setpoint TD_{NRED}, for example.

In this second trajectory segment with a noise abatement 26, the determination module 76 is configured to define a first section 90 enabling an acceleration of the aircraft 10 to a defined setpoint speed VGP, greater than the defined speed V2+MV in the first trajectory segment with a noise abatement 24 and in the initial segment 22, and, once the setpoint speed VGP is reached, a second section 92 authorizing an increase in the slope of the aircraft 10 at the constant setpoint speed VGP to substantially the second total pseudo-slope setpoint TD_{NACC}.

The second total pseudo-slope setpoint TD_{NACC} is constant over the entire second trajectory segment 26, for example. In a variant, the second total pseudo-slope setpoint TD_{NACC} varies along the trajectory segment 26, having a value in the first section 90 lower than the value in the second section 92, for example.

Preferably, the second total pseudo-slope setpoint TD_{NACC} is a constant value for a type of aircraft 10, calculated beforehand during the design of the aircraft 10, and stored in the memory 72.

In a variant, the second total pseudo-slope setpoint TD_{NACC} is determined before the flight, during the establishment of the flight plan of the aircraft 10, for example.

Advantageously, the second total pseudo-slope setpoint TD_{NACC} is calculated from the characteristics of the aircraft 10, in particular its type, number of engines, maximum thrust and/or minimum thrust, noise constraints to be respected, defined on the terrain(s) of interest, the acceleration capacity of the aircraft and performance characteristics to be met established by the aircraft manufacturer, particularly operational criteria such as minimum slopes imposed by the airport and applicable regulatory criteria, such as the Advisory Circular 91-53A, “Noise Abatement Departure Profile” of the Federal Aviation Administration.

In the example represented in FIG. 2, the value of the second total pseudo-slope setpoint TD_{NACC} is advantageously greater than the value of the first total pseudo-slope setpoint TD_{NRED}.

Preferably, this value corresponds to a minimum acceleration of 0.51 m/s⁻² (or 1kt/s), generally 3° above the minimum slope to be respected.

It is between 3° and 8°, for example.

The determination module 76 is also configured to define at least one setpoint slope of the aircraft in each segment with a noise abatement 24, 26, intended for the flight management system 16, particularly to define a flight director symbol.

The floor slope determination module 78 is configured to determine at least one floor slope to be respected by the aircraft 10, corresponding to each trajectory segment 24, 26 with a noise abatement.

In the example illustrated in FIG. 2, the determination module 78 is configured to determine a first section 96 of floor slope having a first value in the first trajectory segment with a noise abatement 24 and a second section of floor slope 98 having a second value in the second trajectory segment with a noise abatement 26.

For example, the determination module 78 is configured to determine the first section 96 of floor slope from the predefined minimum altitude 23 with a slope equal to the value of the first total pseudo-slope setpoint TD_{NRED} defined by the determination module 74 for the first trajectory segment 24, minus a margin MP for taking into account atmospheric conditions external to the aircraft 10 that may locally affect the maintenance of the first total pseudo-slope setpoint TD_{NRED} by the flight control center 56.

For example, the margin MP has a value in degrees of between 1° and 3°.

The slope determination module 78 is further configured to determine the second floor slope section 98 corresponding to the second trajectory segment 26, from the second minimum altitude, as having a slope equal to a minimum slope to be respected to achieve an aircraft acceleration 10 greater than a given minimum acceleration threshold. Advantageously, the given minimum acceleration threshold is determined by evaluator pilots to avoid the sense of lagging in speed.

For example, this threshold is between 0.26 m/s⁻² and 1.03 m/s⁻² (0.5 kt/s and 2 kts/s). This gives the pilot a sense of acceleration.

This minimum slope to be respected is greater than 3°, for example, particularly between 3.5° and 5.5°. It is strictly less than the value of the second total pseudo-slope setpoint TD_{NACC}.

In a variant, the slope determination module 78 is configured to determine the second floor slope section 98 corresponding to the second trajectory segment 26 as having a slope equal to the value of the second total pseudo-slope setpoint TD_{NACC} defined by the determination module 76 for the second trajectory segment 26, minus a margin MP for taking into account atmospheric conditions external to the aircraft 10 that may locally affect the maintenance of the second total pseudo-slope setpoint TD_{NACC} by the flight control center 56.

For example, the margin MP has a value in degrees of between 1° and 3°.

In another variant, the slope determination module 78 is configured to determine the floor slope section 96 having a first value, in the first trajectory segment with a noise abatement 24, as having a slope equal to a minimum slope to be respected to achieve an aircraft acceleration 10 greater than a given minimum acceleration threshold. Advantageously, the given minimum acceleration threshold is determined by evaluator pilots to avoid the sense of lagging in speed.

For example, this threshold is between 0.26 m/s⁻² and 1.03 m/s⁻² (0.5 kt/s and 2 kts/s). This gives the pilot a sense of acceleration.

Advantageously, in one embodiment, the floor slope determined from the first altitude 23 is greater than a minimum slope 97 respecting the presence of obstacles, regulatory constraints and safety margins of the aircraft 10. This slope is greater than 2%, for example, particularly greater than 6%. The slope is between 2.5% and 10%, for example, particularly between 6.5% and 8.5%.

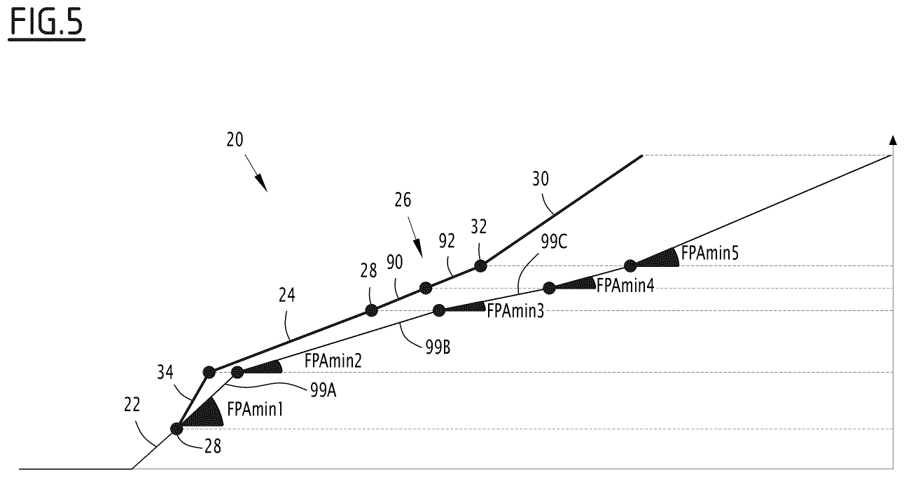

In a variant represented in FIG. 5, the slope determination module 78 is configured to calculate the floor slope precisely for each trajectory segment with a noise abatement 24, 26, taking into account a mapping defining at least one obstacle or trajectory constraint, particularly an airport gradient, concerning each trajectory segment with a noise abatement 24, 26.

Referring to FIG. 1, the determination module 78 is thus configured to determine multiple trajectory segments with a noise abatement 24, 26, and, correspondingly, multiple floor slope sections 99A, 99B, 99C, each having a distinct slope value.

In this case, each trajectory segment with a noise abatement 24, 26 has an entry altitude, a setpoint speed, a setpoint slope, a total pseudo-slope setpoint TD_{NRED}, TD_{NACC} (which can be identical, for two successive trajectory segments 26, for example) and its own floor slope.

Upon user validation via the human-machine interface 86, for example, the transmission module 80 is suitable for transmitting the characteristics of the trajectory segments 22, 24, 26, as well as the floor slope sections 96, 98; 99A, 99B, 99C corresponding to the trajectory segments 22, 24, 26 from the determination system 12 to the flight management system 16 so that the flight management system 16 can develop precise geographical trajectories of the aircraft 10, as well as thrust management setpoints for the aircraft, expressed in total pseudo-slope, particularly in the trajectory segments with a noise abatement 24, 26, for example.

The screen 82 is a screen specific to the determination system 12, for example, particularly in the case of a non-embedded determination system 12, or is an avionics screen 14 such as a screen of the flight management system 16.

Advantageously, the display manager 84 comprises at least one graphics card connected to the determination modules 74, 76, 78. It comprises at least one processor and a memory equipped with graphics execution modules, suitable for generating a display on the screen 82 to display a graphical representation of the trajectory 20 in a vertical plane, as visible in FIG. 2.

The flight management system 14 comprises at least one computer 100, for example, comprising a processor 102 and a memory 104 containing software modules configured to be executed by the processor 102. In a variant, the flight management system 14 at least partially takes the form of one or more programmable circuits, such as of the FPGA type (from the English, “Field-Programmable Gate Array”) or in the form of a dedicated electronic circuit of the ASIC type (from the English, “Application-Specific Integrated Circuit”).

The flight management system 14 is configured to assist the aircraft pilot in conducting the navigation of the aircraft 10 during a mission. It is configured to provide information particularly on the route followed by the aircraft 10, and on the evolution parameters of the aircraft 10, such as fuel consumption.

It is also configured to guide the aircraft 10 to make it follow a predetermined trajectory. Advantageously, the flight management system 14 includes a vertical guidance module 104 of the aircraft 10, to make it follow a given vertical trajectory.

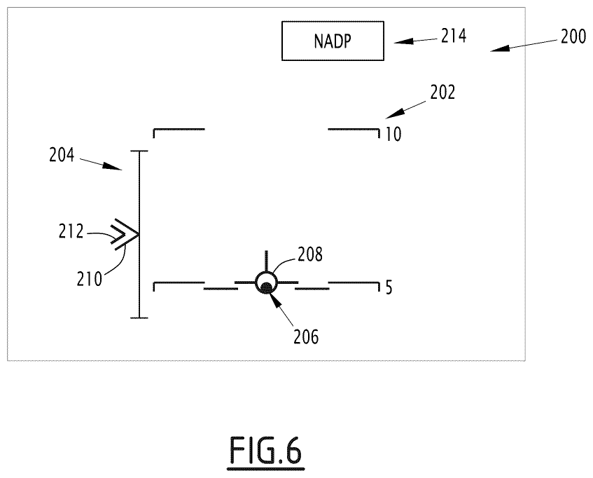

Preferably, the vertical guidance module 104 is configured to receive characteristics of the trajectory 20 established by the determination system 12 and to generate at least one guidance symbol, in particular a flight director symbol 206 compared to a slope scale 202 on a cockpit screen 200 of the aircraft 10 (see FIG. 6) to enable the pilot to manually follow the trajectory 20. In a known manner, the pilot can thus align the instantaneous aircraft slope, measured by the aircraft sensors 10 and materialized by an aircraft model 208, with the flight director 206.

The flight management system 14 comprises at least one module 106 for calculating a total pseudo-slope to be applied on the trajectory 20, for example, particularly using the total pseudo-slope values determined by the determination system 12, and to generate at least one guidance symbol on a cockpit screen of the aircraft 10, such as a first chevron 210 beside the slope scale 202, to enable the pilot to manually apply the total pseudo-slope setpoint with the help of the movable lever 60, by using an instantaneous value of the total pseudo-slope of the aircraft 10. The instantaneous value of the total pseudo-slope of the aircraft 10 is calculated by the above equation from measurements of the aircraft sensors 10, for example, and is materialized by a second chevron 212 on a total pseudo-slope scale 204, for example, to be aligned with the first chevron 210.

The autopilot system 42 is configured to automate tasks such as maintaining an altitude, climbing or descending to a given altitude, turning and maintaining a given heading, intercepting a trajectory, guiding the aircraft 10 between waypoints that constitute a programmed route in the flight management system 16 and executing a precision or non-precision approach.

The autopilot system 42 comprises a set of servomotors that execute the control movement and control circuits so that the servomotors move the correct amount for the selected task.

The autopilot system 42 is configured to provide the computing power necessary to accomplish the flight tasks, including receiving navigation data, data from the flight management system 16, environmental data, selected autopilot data and data from other data sources, and to calculate the necessary commands to operate the aircraft 10 in the desired manner.

In particular, the autopilot system 42 is configured to enable automatically following the trajectory 20 whose characteristics have been established by the determination system 12, from data received from the flight management system 16, by successively passing in an autopilot takeoff T/O mode to execute the initial segment 22, then in an automatic noise abatement NADP piloting mode to execute the segments 24, 26 with a noise abatement.

Further, in the automatic noise abatement NADP piloting mode, the autopilot system 42 is configured to control the total pseudo-slope of the aircraft 10 depending on the total pseudo-slope setpoint value defined for the segments 24, 26 and, advantageously, to control the mobile neutral position of the movable lever 60.

The implementation of an aircraft trajectory 20 with a noise abatement departure procedure will now be described.

Initially, the determination system 12 is activated to define the characteristics of the trajectory 20. To this end, the determination module 74 determines the characteristics of the initial trajectory segment 22 made at maximum thrust, including its setpoint slope, the applied thrust and the first predefined minimum altitude 23 at which this segment 22 ends.

The determination module 76 then determines the characteristics of the trajectory segments with a noise abatement 24, 26. In particular, it determines, from the memory 72, for example, the setpoint slope, the value of the first total pseudo-slope setpoint TD_{NRED} of the first trajectory segment 24, as well as the constant speed V2+MV to be maintained during the first trajectory segment 24, and the second altitude 28 at which the first trajectory segment 16 ends.

The determination module 76 further determines the characteristics of the second trajectory segment 26, including the setpoint slope, the value of the second total pseudo-slope setpoint TD_{NACC}, greater than the value of the first total pseudo-slope setpoint TD_{NRED}, the setpoint speed VGP to be reached, and, possibly, the chosen altitude 32 at the end of the second trajectory segment.

With regard to each trajectory segment 24, 26 with a noise abatement, the determination module 78 determines the floor slope to be respected.

In the example represented in FIG. 2, the determination module 78 thus determines a first floor slope section 96, for example, with a floor slope value equal to the value of the first total pseudo-slope setpoint TD_{NRED} minus a margin MP for taking into account atmospheric conditions, with the first section 96 corresponding to the first trajectory segment with a noise abatement 24.

It also determines a second floor slope section 98, for example, with a constant floor slope value configured to respect an aircraft acceleration 10 greater than the given minimum acceleration threshold, with the second section 98 corresponding to the second trajectory segment with a noise abatement 26.

The characteristics of the initial segment 22, the first and second trajectory segments with a noise abatement 24, 26, and the floor slope sections 96, 98 corresponding to the first and second trajectory segments with a noise abatement 24, 26 are then transmitted to the flight management system 16 via the transmission module 80, upon user validation via the human-machine interface 86, for example.

The flight management system 16 then develops precise geographical trajectories of the aircraft 10, as well as slope and thrust management setpoints for the aircraft, the latter being expressed in total pseudo-slope in the trajectory segments with a noise abatement 24, 26, for example.

The trajectory 20 thus determined is displayed on a screen 82 by the display manager 84 to enable the pilot to visualize the trajectory 20 and possibly adjust or modify it.

During the flight and after the takeoff of the aircraft 10, the pilot in manual piloting mode or the autopilot system 42 in an autopilot takeoff T/O mode follows the initial trajectory segment 22 at maximum thrust and constant speed equal to the takeoff speed V2 plus the speed margin MV up to the first predefined minimum altitude 23.

When it passes this altitude 23, the pilot in manual piloting mode or the autopilot system 42 in an automatic noise abatement NADP mode then follows each trajectory segment with a noise abatement 24, 26, adjusting the total pseudo-slope to respect the first total pseudo-slope setpoint TD_{NRED} up to the second altitude 28, then the second total pseudo-slope setpoint TD_{NACC} up to the chosen altitude 32.

As illustrated in FIG. 6, on the cockpit screen 200, the flight director symbol 206 is placed on the slope scale 202 at the setpoint slope value that the pilot or the autopilot system 42 must follow to respect the setpoint slope. When the pilot or the autopilot system adjusts the slope of the aircraft 10 accordingly, the aircraft model 208 materializing the instantaneous slope of the aircraft is placed in alignment with the flight director symbol 206.

Similarly, a total pseudo-slope guidance symbol, particularly a first chevron 210, is displayed next to the slope scale 202, at the value of the total pseudo-slope setpoint TD_{NRED}, TD_{NACC} that the pilot or the autopilot system 42 must follow. When the pilot or the autopilot system adjusts the total pseudo-slope of the aircraft 10 accordingly, a second chevron 212 materializing the instantaneous total pseudo-slope of the aircraft 10 is placed in alignment with the total pseudo-slope guidance symbol.

An indicator 214 of the automatic noise abatement NADP mode is displayed on the cockpit screen 200 when this mode is activated.

In the first trajectory segment with a noise abatement 24, the aircraft 10 climbs, following the first total pseudo-slope setpoint TD_{NRED}, at constant speed equal to the same speed V2+MV as that of the initial segment 22.

The slope of the aircraft 10 then corresponds substantially to the first total pseudo-slope setpoint TD_{NRED}. The pilot or the autopilot system 42 maintains the slope of the aircraft 10 at all times above the floor slope defined in the first section 96 of floor slope as equal to the value of the first total pseudo-slope setpoint TD_{NRED} minus a margin MP for taking into account atmospheric conditions.

Then, when it reaches the second altitude 28, the pilot in manual piloting mode or the autopilot system 42 in the automatic noise abatement NADP mode modifies the total pseudo-slope setpoint to reach the second total pseudo-slope setpoint TD_{NACC} defined by the determination system 12.

Optionally, a transition such as a ramp can be defined by the determination system 12, to transition from the first total pseudo-slope setpoint TD_{NRED} to the second total pseudo-slope setpoint TD_{NACC}.

In the first section 90 of the second trajectory segment with a noise abatement 26, the speed of the aircraft increases progressively to the defined setpoint speed VGP for the second trajectory segment with a noise abatement 26. The aircraft 10 then remains above the floor slope defined by the second section 98 of floor slope at all times. This floor slope value is advantageously equal to the constant slope value to respect an aircraft acceleration 10 greater than the given minimum acceleration threshold.

Then, in the second section 92 of the second trajectory segment with a noise abatement 26, when the setpoint speed VGP has been reached, the aircraft 10 increases its slope to progressively reach the value of the second total pseudo-slope setpoint TD_{NACC}.

When the chosen altitude 32 is reached, the pilot or the autopilot system 42 switches to an automatic climb piloting mode to further accelerate the aircraft 10 and follow the defined flight plan.

In the variant represented in FIG. 4, for a distant abatement procedure, the pilot in manual piloting mode or the autopilot system 42 in an automatic takeoff T/O piloting mode follows the first initial trajectory segment 22 at maximum thrust and constant speed equal to the takeoff speed V2 plus the speed margin MV up to the first predefined minimum altitude 23. Then, upon passing the first altitude 23, it follows the second initial segment 34, during which flaps and slats are retracted, maintaining the total pseudo-slope setpoint for this second initial segment 34 equal to the total pseudo-slope TO at maximum engine speed.

Then, when it reaches the second altitude 28, the pilot in manual piloting mode or the autopilot system 42 in the automatic noise abatement NADP mode modifies the total pseudo-slope setpoint to reach the second total pseudo-slope setpoint TD_{NACC} defined by the determination system 12. In this latter case, the value of the total pseudo-slope setpoint TD_{NACC} of the distant noise abatement segment 24 is less than the value of the total pseudo-slope TO.

More generally, the start of the noise abatement segment 26 setting the total pseudo-slope setpoint TD_{NACC} can be defined by the determination system 12 and implemented by the pilot in manual piloting mode or by the autopilot system 42 in the automatic noise abatement NADP mode, from the start of acceleration or during acceleration based on an altitude, speed or aircraft state (such as flaps retracted).

The criteria for defining the value of the total pseudo-slope setpoint TD_{NACC} for the trajectory in FIG. 4 are advantageously those described above for the second noise abatement segment 26 of the trajectory visible in FIG. 2.

By means of the instruction of a total pseudo-slope setpoint TD_{NRED}, TD_{NACC} as a thrust setpoint in each trajectory segment with a noise abatement 24, 26, it is possible to have a single easily accessible parameter to implement the thrust reduction and thus the noise abatement. The definition of a total pseudo-slope setpoint TD_{NRED}, TD_{NACC} thus offers the pilot a much simpler adjustment than an engine setting that requires a complex calculation of N1, of EPR, of lever position.

In particular, the pilot does not have to consult multi-entry tables to determine an engine parameter setpoint or a vertical parameter setpoint for each mission preparation, since the total pseudo-slope setpoint takes into account the weight, temperature, altitude and aircraft configuration in a single parameter that is homogeneous to a slope, and is therefore simple to anticipate and understand for the pilot.

Unlike a solution where a maximum thrust percentage is set, and in which the thrust depends on controlling this setting, the aircraft trajectory 20 at constant speed is straight.

Further, the piloting of the aircraft 10 adapts directly to the aircraft configuration, since when the configuration of the flaps and/or slats is modified, maintaining the total pseudo-slope setpoint TD_{NRED}, TD_{NACC} contributes to reducing the thrust and thus the noise.

Similarly, in the event of an engine failure, the thrust of the healthy engine adapts immediately to continue to follow the desired total pseudo-slope setpoint TD_{NRED}, TD_{NACC}, and thus the desired trajectory 20, until the maximum healthy engine thrust is reached.

Furthermore, the floor slope defined for each trajectory segment with a noise abatement 24, 26 enables the aircraft 10 to fly with just enough thrust to optimize the trajectory, in particular the noise and comfort, while avoiding approaching constraints such as obstacles or airport gradients. An adequate safety margin is ensured by the defined and maintained minimum floor slope in each floor slope section 96, 98; 99A, 99B, 99C.

Thus, the trajectory 20 defined by the determination system 12 and flown by the aircraft 10 presents an adequate safety margin in relation to obstacles and follows regulations and airport gradients. It is further possible to strictly respect the constraints that apply in areas near an airfield, by calculating several floor slope sections 99A, 99B, 99C for each trajectory segment with a noise abatement 24, 26, for example, with each corresponding to trajectory sub-segments with an identical floor slope. This offers the possibility of finely managing noise along the trajectory 20 during noise abatement.

In a variant, visible in FIG. 1, the flight management system 16 and/or the determination system 12 includes a module 108 for comparing the slope flown by the aircraft 10 at each position of the aircraft and the floor slope defined on the trajectory 20 for this position of the aircraft 10, and a module 110 for triggering an alarm or increasing thrust when the flown slope falls below the floor slope.

In another variant, the characteristics of each of the initial segment 22 and the trajectory segments with a noise abatement 24, 26 are directly present in a memory of the flight management system 16 and are not configurable using a determination system 12.

In a variant, the determination system 12 comprises modules 74, 76 for determining the characteristics of the initial segment 22 and the first and second trajectory segments with a noise abatement 24, 26. However, the determination system 12 does not comprise a module for determining a floor slope. In this variant, the floor slope is neither determined nor monitored during the flight.

In another variant, trajectories with a noise abatement not using a total pseudo-slope setpoint are determined by the determination system 12 and/or flown by the aircraft 10, based on a reduced engine speed setpoint (“rating” in English), N1 percentage or EPR, for example. In this variant, a floor slope is determined by the determination system 12 for each trajectory segment with a noise abatement 24, 26 of the trajectory 20 in which the engine thrust is reduced.

What is claimed is:

1. A method to determine an aircraft trajectory with a noise abatement departure procedure, the determination method being implemented using a determination system, the method comprising:
determining characteristics of at least one initial trajectory segment made at a maximum thrust up to a predefined minimum altitude; and
determining characteristics of at least one trajectory segment with a noise abatement, with a reduced thrust compared to the maximum thrust to reach a setpoint speed, comprising defining at least one total pseudo-slope setpoint ensuring the reduced thrust.

2. The determination method according to claim 1, wherein determining characteristics of at least one trajectory segment with a noise abatement comprises defining characteristics of a first trajectory segment comprising a constant speed and a first total pseudo-slope setpoint.

3. The determination method according to claim 2, wherein determining characteristics of at least one trajectory segment with a noise abatement comprises, beyond a second threshold altitude, defining characteristics of a second trajectory segment, including a second total pseudo-slope setpoint ensuring aircraft acceleration from the constant speed to the setpoint speed, a value of the second total pseudo-slope setpoint being greater than a value of the first total pseudo-slope setpoint.

4. The determination method according to claim 3, wherein the second trajectory segment includes an increase in a slope of the aircraft to a value corresponding to the second total pseudo-slope setpoint after reaching the setpoint speed.

5. The determination method according to claim 1, wherein determining at least one trajectory segment with a noise abatement with a reduced thrust compared to the maximum thrust is made from the predefined minimum altitude of a first initial trajectory segment or wherein determining characteristics of at least one initial trajectory segment comprises determining a first initial trajectory segment up to a predefined minimum altitude, then determining a second initial trajectory segment from the first predefined minimum altitude to a second predefined minimum altitude, during which flaps and slats are retracted, with determining at least one trajectory segment with a noise abatement with reduced thrust compared to the maximum thrust being made from the second predefined minimum altitude.

6. The determination method according to claim 1, comprising displaying a representation of the trajectory on a screen of the determination system, comprising the initial trajectory segment and the or each trajectory segment with a noise abatement and/or transmitting the characteristics of the initial trajectory segment and defined characteristics of the or each trajectory segment with a noise abatement to a flight management system of the aircraft for display on a cockpit screen of at least one total pseudo-slope guidance symbol corresponding to the total pseudo-slope setpoint ensuring reduced thrust.

7. A method to pilot an aircraft following an aircraft trajectory with a noise abatement departure procedure, comprising:
following at least one initial trajectory segment made at a maximum thrust up to a predefined minimum altitude;
following at least one trajectory segment with a noise abatement with a reduced thrust compared to the maximum thrust to reach a setpoint speed, following the at least one trajectory segment with a noise abatement comprising following at least one total pseudo-slope setpoint ensuring the reduced thrust.

8. The method according to claim 7, wherein following at least one trajectory segment with a noise abatement comprises following a first trajectory segment with a constant speed and a first total pseudo-slope setpoint and wherein following at least one trajectory segment with a noise abatement comprises, beyond a second threshold altitude, following a second trajectory segment which has a second total pseudo-slope setpoint ensuring an aircraft acceleration from the constant speed to the setpoint speed, a value of the second total pseudo-slope setpoint being greater than a value of the first total pseudo-slope setpoint.

9. A system to determine an aircraft trajectory with a noise abatement departure procedure, the system being configured to:
determine characteristics of at least one initial trajectory segment made at a maximum thrust up to a predefined minimum altitude;
determine characteristics of at least one trajectory segment with a noise abatement with a reduced thrust compared to the maximum thrust to reach a setpoint speed, including defining at least one total pseudo-slope setpoint ensuring the reduced thrust.

10. The system according to claim 9, comprising a screen and a display manager on the screen configured to display a representation of the trajectory comprising the initial trajectory segment and the or each trajectory segment with a noise abatement and/or being configured to transmit the characteristics of the initial trajectory segment and defined characteristics of the or each trajectory segment with a noise abatement to a flight management system of the aircraft, the system comprising a cockpit screen and a display manager on the cockpit screen configured to display on the cockpit screen at least one total pseudo-slope guidance symbol corresponding to the total pseudo-slope setpoint ensuring the reduced thrust.

11. An aircraft, comprising a flight management system configured to follow a trajectory with a noise abatement departure procedure or configured to guide a pilot along a trajectory with a noise abatement departure procedure, the trajectory comprising:
at least one initial trajectory segment made at a maximum thrust up to a predefined minimum altitude;
at least one trajectory segment with a noise abatement with a reduced thrust compared to the maximum thrust to reach a setpoint speed, the at least one trajectory segment with a noise abatement being defined by at least one total pseudo-slope setpoint ensuring the reduced thrust or/and the trajectory comprising:
an initial trajectory segment performed at maximum thrust up to a predefined minimum altitude; and
at least one trajectory segment with a noise abatement with a reduced thrust compared to maximum thrust to reach a target speed,
the flight management system being configured to maintain at least one floor slope to be observed by the aircraft in correspondence with the or each trajectory segment with a noise abatement.

12. A method to determine a trajectory of an aircraft with a noise abatement departure procedure, the determination method being implemented using a determination system, the method comprising:
determining characteristics of an initial trajectory segment performed at a maximum thrust up to a predefined minimum altitude;
determining characteristics of at least one trajectory segment with a noise abatement with a reduced thrust compared to maximum thrust to reach a target speed; and
defining at least one floor slope to be observed by the aircraft in correspondence with the or each trajectory segment with a noise abatement.

13. The determination method according to claim 12, comprising defining a plurality of floor slope sections, each floor slope section defining a distinct floor slope.

14. The determination method according to claim 13, comprising at least two trajectory segments with a noise abatement, the respective floor slope sections associated with each trajectory segment with a noise abatement having different floor slopes from one another.

15. The determination method according to claim 13, in which defining each floor slope section is carried out based on a mapping defining at least one obstacle or trajectory constraint, in view of the or each trajectory segment with a noise abatement.

16. The determination method according to claim 12, comprising defining a common floor slope corresponding to several trajectory segments with a noise abatement.

17. The determination method according to claim 12, comprising displaying on a screen of the determination system, a representation of the trajectory comprising the initial trajectory segment and the or each trajectory segment with a noise abatement, with the floor slope to be observed by the aircraft in correspondence with the or each trajectory segment with a noise abatement and/or a transmission of the characteristics of the initial trajectory segment and the defined characteristics of the or each trajectory segment with a noise abatement, as well as the floor slope to be observed by the aircraft in correspondence with the or each trajectory segment with a noise abatement, to a flight management system of the aircraft.

18. A method to pilot an aircraft following a trajectory of an aircraft with a noise abatement departure procedure, comprising:
following an initial trajectory segment performed at a maximum thrust up to a predefined minimum altitude;
following at least one trajectory segment with a noise abatement with a reduced thrust compared to the maximum thrust to reach a target speed; and
maintaining a slope of the aircraft above a floor slope to be observed by the aircraft defined in correspondence with the or each trajectory segment with a noise abatement with a reduced thrust, during an implementation of the or each trajectory segment with a noise abatement.

19. The method according to claim 18, comprising, during the implementation of at least one trajectory segment with a noise abatement, comparing a real slope of the aircraft with the floor slope, and issuing alert information in case the real slope becomes lower than the floor slope.

20. A system for determining a trajectory of an aircraft with a noise abatement departure procedure, the system being configured to
determine characteristics of an initial trajectory segment performed at maximum thrust up to a predefined minimum altitude;
determine characteristics of at least one trajectory segment with a noise abatement with reduced thrust compared to maximum thrust to reach a target speed; and
define at least one floor slope to be observed by the aircraft in correspondence with the or each trajectory segment with a noise abatement.
